(19) United States
(12) Patent Application Publication
(10) Pub. No.: US 2025/0148762 A1
(43) Pub. Date: May 8, 2025

(54) APPARATUS FOR BUILDING A DEEP LEARNING MODEL FOR IMAGE LEARNING, AND A METHOD THEREOF

(71) Applicants: HYUNDAI MOTOR COMPANY, Seoul (KR); KIA CORPORATION, Seoul (KR)

(72) Inventors: Jun Yong Choi, Seongnam-si (KR); Jae Hoon Cho, Seoul (KR); Jae Hyeon Park, Seoul (KR); Hyun Kook Park, Seoul (KR)

(73) Assignees: HYUNDAI MOTOR COMPANY, Seoul (KR); KIA CORPORATION, Seoul (KR)

(21) Appl. No.: 18/774,313

(22) Filed: Jul. 16, 2024

(30) Foreign Application Priority Data
Nov. 6, 2023 (KR) 10-2023-0151997

(51) Int. Cl. G06V 10/771; G06V 10/44

(52) U.S. Cl. CPC G06V 10/771; G06V 10/44

(57) ABSTRACT

An apparatus for building a deep learning model for image learning includes a first deep learning model configured to obtain a first spatial feature map and a first heatmap including center information of an object belonging to an image by learning the image. The apparatus also includes a second deep learning model configured to perform imitation learning on the first deep learning model. The second deep learning model may obtain a second spatial feature map by learning the image and perform learning such that the second spatial feature map imitates the first spatial feature map. The second deep learning model may also obtain a second heatmap including a center of the object and perform learning such that the second heatmap imitates the first heatmap.

### CROSS-REFERENCE TO RELATED APPLICATION

This application claims the benefit of and priority to Korean Patent Application No. 10-2023-0151997, filed on Nov. 6, 2023, the entire contents of which are incorporated herein by reference.

### TECHNICAL FIELD

The present disclosure relates to an apparatus for building a deep learning model for image learning, and a method thereof.

### BACKGROUND

An autonomous vehicle refers to a vehicle capable of driving on its own without intervention of a driver or a passenger. Automated vehicle & highway system refers to a system that monitors and controls the autonomous vehicle such that the autonomous vehicle is capable of driving on its own. Technologies are being proposed to monitor the outside of a vehicle for a driver's assistance and to operate various driving aids based on the monitored external environment of the vehicle.

Operations of the automated vehicle & highway systems or driving aids may be controlled based on the results of monitoring the outside of the vehicle.

A camera, Light Detection and Ranging (LiDAR), or Radio Detection and Ranging (RADAR) may be used to monitor the outside of the vehicle. A monitoring technology using the camera is being widely researched. Moreover, to monitor the outside of a vehicle using the camera, it is common to use a deep learning model that learns artificial intelligence from images obtained by the camera.

To ensure the safety of autonomous vehicles and to prevent traffic congestion, the object detection performance of deep learning models used in autonomous vehicles is very important. However, deep learning models having high performance in detecting objects from images generally require a large amount of computation and large capacity. Accordingly, it may be difficult to apply high-performance deep learning models to autonomous vehicles that need to determine driving environments in real time within a short period of time.

Furthermore, because the deep learning model is typically implemented with an embedded system together with other control devices of the autonomous vehicle, the types of deep learning models capable of being selected to optimize the embedded systems may be limited.

### SUMMARY

The present disclosure has been made to solve the above-mentioned problems occurring in the prior art while advantages achieved by the prior art are maintained intact.

An aspect of the present disclosure provides an apparatus for building a deep learning model for image learning capable of improving object detection performance while performing fast calculations in real time, and a method thereof.

An aspect of the present disclosure provides an apparatus for building a deep learning model for image learning capable of building an embedded system optimized for autonomous vehicles, and a method thereof.

The technical problems to be solved by the present disclosure are not limited to the aforementioned problems. Other technical problems not mentioned herein should be clearly understood from the following description by those having ordinary skill in the art to which the present disclosure pertains.

According to an aspect of the present disclosure, an apparatus for building a deep learning model for image learning is provided. The apparatus includes a first deep learning model configured to obtain, by learning an image, a first spatial feature map and a first heatmap including center information of an object belonging to the image. The apparatus also includes a second deep learning model configured to perform imitation learning on the first deep learning model. The second deep learning model is configured to obtain a second spatial feature map by learning the image and perform learning such that the second spatial feature map imitates the first spatial feature map. The second deep learning model is also configured to obtain a second heatmap including a center of the object and perform learning such that the second heatmap imitates the first heatmap.

According to an embodiment, the second deep learning model may be configured to output the second spatial feature map through a backbone.

According to an embodiment, the first deep learning model may be configured to obtain a first representative feature value of feature values arranged in a straight direction in the first spatial feature map and obtain a first feature vector of a single row by sorting the first representative feature value. The second deep learning model may be configured to obtain a second representative feature value of feature values arranged in a straight direction in the second spatial feature map. The second deep learning model may also be configured to obtain a second feature vector of a single row by sorting the second representative feature value and perform imitation learning to reduce a difference between the second feature vector and the first feature vector.

According to an embodiment, the first deep learning model may be configured to obtain a first height feature value based on the feature values having x-axis coordinate values same as each other and obtain a first height feature vector based on the first height feature value. The first deep learning model may also be configured to obtain a first width feature value based on the feature values having y-axis coordinate values same as each other and obtain a first width feature vector based on the first width feature value. The second deep learning model may be configured to obtain a second height feature value based on the feature values having the x-axis coordinate values same as each other and obtain a second height feature vector based on the second height feature value. The second deep learning model may also be configured to obtain a second width feature value based on the feature values having the y-axis coordinate values same as each other and obtain a second width feature vector based on the second width feature value.

According to an embodiment, the second deep learning model may be configured to perform learning to reduce a difference between the second height feature vector and the first height feature vector. The second deep learning model may also be configured to perform learning to reduce a difference between the second width feature vector and the first width feature vector.

According to an embodiment, the first deep learning model may be configured to obtain a first height distribution by normalizing the first height feature vector and obtain a first width distribution by normalizing the first width feature vector. The second deep learning model may be configured to obtain a second height distribution by normalizing the second height feature vector and obtain a second width distribution by normalizing the second width feature vector. The second deep learning model may also be configured to perform learning such that the second height distribution imitates the first height distribution and the second width distribution imitates the first width distribution.

According to an embodiment, the second deep learning model may output the second heatmap through a head.

According to an embodiment, the first deep learning model may be configured to obtain a first representative center value of center values arranged in a straight direction in the first heatmap and obtain a first center vector of a single row by sorting the first representative center value. The second deep learning model may be configured to obtain a second representative center value of center values arranged in a straight direction in the second heatmap and obtain a second center vector of a single row by sorting the second representative center value. The second deep learning model may also be configured to perform imitation learning to reduce a difference between the second center vector and the first center vector.

According to an embodiment, the first deep learning model may be configured to obtain a first height center value based on the center values having x-axis coordinate values same as each other and obtain a first height center vector based on the first height center value. The first deep learning model may also be configured to obtain a first width center value based on the center values having y-axis coordinate values same as each other and obtain a first width center vector based on the first width center value. The second deep learning model may be configured to obtain a second height center value based on the center values having the x-axis coordinate values same as each other and obtain a second height center vector based on the second height center value. The second deep learning model may also be configured to obtain a second width center value based on the center values having the y-axis coordinate values same as each other and obtain a second width center vector based on the second width center value.

According to an embodiment, the second deep learning model may be configured to perform learning to reduce a difference between the second height center vector and the first height center vector. The second deep learning model may also be configured to perform learning to reduce a difference between the second width center vector and the first width center vector.

According to an embodiment, the first deep learning model may be configured to obtain a first height distribution by normalizing the first height center vector and obtain a first width distribution by normalizing the first width center vector. The second deep learning model may be configured to obtain a second height distribution by normalizing the second height center vector and obtain a second width distribution by normalizing the second width center vector. The second deep learning model may also be configured to perform learning such that the second height distribution imitates the first height distribution and the second width distribution imitates the first width distribution.

According to another aspect of the present disclosure, a method for building a deep learning model for image learning is provided. The method includes obtaining a first spatial feature map and a first heatmap including center information of an object belonging to an image by learning the image based on a first deep learning model. The method also includes obtaining a second spatial feature map by learning the image based on a second deep learning model. The method additionally includes performing learning of the second deep learning model such that the second spatial feature map imitates the first spatial feature map. The method further includes obtaining a second heatmap including a center of the object based on the second deep learning model. The method further still includes performing learning of the second deep learning model such that the second heatmap imitates the first heatmap.

According to an embodiment, performing learning of the second deep learning model such that the second spatial feature map imitates the first spatial feature map may include obtaining a first representative feature value of feature values arranged in a straight direction in the first spatial feature map. Performing learning of the second deep learning model may also include obtaining a first feature vector of a single row by sorting the first representative feature value. Performing learning of the second deep learning model may additionally include obtaining a second representative feature value of feature values arranged in a straight direction in the second spatial feature map. Performing learning of the second deep learning model may further include obtaining a second feature vector of a single row by sorting the second representative feature value. Performing learning of the second deep learning model may further still include learning the second deep learning model to reduce a difference between the second feature vector and the first feature vector.

According to an embodiment, obtaining the first feature vector may include obtaining a first height feature value based on the feature values having x-axis coordinate values same as each other. Obtaining the first feature vector may also include obtaining a first height feature vector based on the first height feature value and obtaining a first width feature value based on the feature values having y-axis coordinate values same as each other. Obtaining the first feature vector may further include obtaining a first width feature vector based on the first width feature value. Obtaining the second feature vector may include obtaining a second height feature value based on the feature values having the x-axis coordinate values same as each other and obtaining a second height feature vector based on the second height feature value. Obtaining the second feature vector may also include obtaining a second width feature value based on the feature values having the y-axis coordinate values same as each other and obtaining a second width feature vector based on the second width feature value.

According to an embodiment, performing learning of the second deep learning model such that the second spatial feature map imitates the first spatial feature map may include performing learning to reduce a difference between the second height feature vector and the first height feature vector and performing learning to reduce a difference between the second width feature vector and the first width feature vector.

According to an embodiment, performing learning of the second deep learning model such that the second spatial feature map imitates the first spatial feature map may further include obtaining a first height distribution by normalizing the first height feature vector. Performing learning of the second deep learning model may additionally include obtaining a first width distribution by normalizing the first width feature vector and obtaining a second height distribution by normalizing the second height feature vector. Performing learning of the second deep learning model may further include obtaining a second width distribution by normalizing the second width feature vector. Performing learning of the second deep learning model may additionally include performing learning of the second deep learning model such that the second height distribution imitates the first height distribution and the second width distribution imitates the first width distribution.

According to an embodiment, performing learning of the second deep learning model such that the second heatmap imitates the first heatmap may include obtaining, by the first deep learning model, a first representative center value of center values arranged in a straight direction in the first heatmap. Performing learning of the second deep learning model may also include obtaining, by the first deep learning model, a first center vector of a single row by sorting the first representative center value. Performing learning of the second deep learning model may further include obtaining, by the second deep learning model, a second representative center value of center values arranged in a straight direction in the second heatmap. Performing learning of the second deep learning model may additionally include obtaining, by the second deep learning model, a second center vector of a single row by sorting the second representative center value. Performing learning of the second deep learning model may further include performing, by the second deep learning model, imitation learning to reduce a difference between the second center vector and the first center vector.

According to an embodiment, performing learning of the second deep learning model such that the second heatmap imitates the first heatmap may include obtaining, by the first deep learning model, a first height center value based on the center values having x-axis coordinate values same as each other. Performing learning of the second deep learning model may also include obtaining a first height center vector based on the first height center value. Performing learning of the second deep learning model may additionally include obtaining, by the first deep learning model, a first width center value based on the center values having y-axis coordinate values same as each other and obtaining a first width center vector based on the first width center value. Performing learning of the second deep learning model may further still include obtaining, by the second deep learning model, a second height center value based on the center values having the x-axis coordinate values same as each other and obtaining a second height center vector based on the second height center value. Performing learning of the second deep learning model may further yet include obtaining, by the second deep learning model, a second width center value based on the center values having the y-axis coordinate values same as each other and obtaining a second width center vector based on the second width center value.

According to an embodiment, performing learning of the second deep learning model such that the second heatmap imitates the first heatmap may include learning the second deep learning model to reduce a difference between the second height center vector and the first height center vector. Performing learning of the second deep learning model may also include learning the second deep learning model to reduce a difference between the second width center vector and the first width center vector.

According to an embodiment, performing learning of the second deep learning model such that the second heatmap imitates the first heatmap may include obtaining, by the first deep learning model, a first height distribution by normalizing the first height center vector and obtaining a first width distribution by normalizing the first width center vector. Performing learning of the second deep learning model may additionally include obtaining, by the second deep learning model, a second height distribution by normalizing the second height center vector. Performing learning of the second deep learning model may further include obtaining a second width distribution by normalizing the second width center vector. Performing learning of the second deep learning model may further still include performing, by the second deep learning model, learning such that the second height distribution imitates the first height distribution and the second width distribution imitates the first width distribution.

### BRIEF DESCRIPTION OF THE DRAWINGS

The above and other objects, features, and advantages of the present disclosure should be more apparent from the following detailed description taken in conjunction with the accompanying drawings, in which:

FIG. 1 illustrates an example of a configuration of an object detection apparatus equipped with a deep learning model, according to an embodiment of the present disclosure;

FIG. 2 illustrates an example of a vehicle equipped with an object detection apparatus, according to an embodiment of the present disclosure;

FIG. 3 illustrates an example of an apparatus for building a deep learning model, according to an embodiment of the present disclosure;

FIG. 4 illustrates an example of a method of building a deep learning model, according to an embodiment of the present disclosure;

FIG. 5 illustrates an example of imitation learning of a backbone network, according to an embodiment of the present disclosure;

FIG. 6 illustrates an example of a method of obtaining a feature vector;

FIG. 7 illustrates an example of imitation learning of a head, according to an embodiment of the present disclosure;

FIG. 8 illustrates an example of a method of obtaining a center vector; and

FIG. 9 illustrates an example of a computing system according to an embodiment of the present disclosure.

### DETAILED DESCRIPTION

Hereinafter, embodiments of the present disclosure are described in detail with reference to the accompanying drawings. In the accompanying drawings, the same components are designated by the same reference numerals even when the components are illustrated on different drawings. Furthermore, in describing the embodiments of the present disclosure, detailed descriptions associated with well-known functions or configurations have been omitted when it was determined that the detailed descriptions may make subject may unnecessarily obscure the gist of the present disclosure.

In describing elements of an embodiment of the present disclosure, terms such as first, second, A, B, (a), (b), and the like may be used. These terms are only used to distinguish one element from another element. The terms do not limit the corresponding elements irrespective of the nature, order, or priority of the corresponding elements. Furthermore, unless otherwise defined, all terms including technical and scientific terms used herein should be interpreted as is customary in the art to which the present disclosure pertains. It should be understood that terms used herein should be interpreted as including a meaning that is consistent with their meaning in the context of the present disclosure and the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

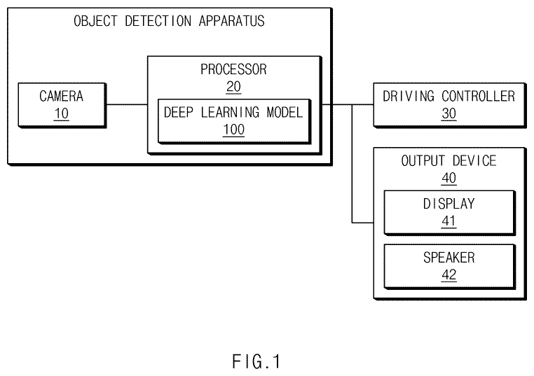

Hereinafter, various embodiments of the present disclosure are described in detail with reference to FIGS. 1-8.

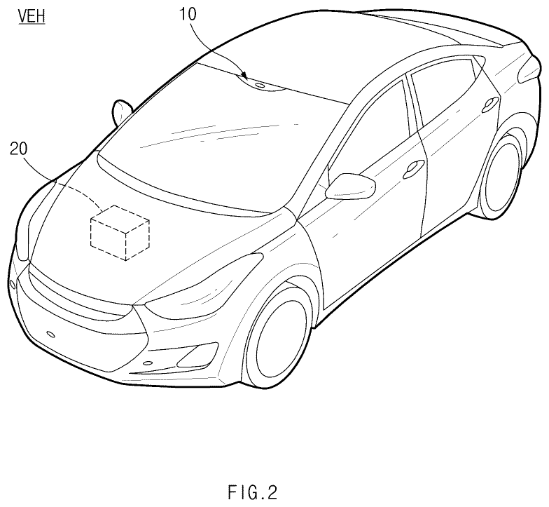

FIG. 1 is a block diagram showing a configuration of an object detection apparatus equipped with a deep learning model, according to an embodiment of the present disclosure. FIG. 2 is a diagram showing a vehicle equipped with an object detection apparatus, according to an embodiment of the present disclosure. Hereinafter, an object detection apparatus is described focusing on an embodiment in which it is mounted on a vehicle as shown in FIG. 2. However, an area in which the object detection apparatus is capable of being utilized may not be limited thereto.

Referring to FIGS. 1 and 2, an object detection apparatus OD according to an embodiment of the present disclosure may include a camera 10 and a processor 20. The processor 20 may include a deep learning model 100 for object recognition.

The camera 10 may be used to obtain an external image of a vehicle. The camera 10 may be positioned to be close to a front windshield or may be positioned, for example, around a front bumper or a radiator grill. The external image may be expressed on a two-dimensional image plane Each of pixels on the image plane may be expressed as image coordinates.

The processor 20 may use an object classification model for classifying objects in the external image obtained by the camera 10. The object classification model may be included in the processor 20 or may be stored in an external memory. The object classification model may use a vision transformer. The vision transformer may use the sequence of image patches as an input without relying on convolutional neural networks (CNN).

The processor 20 may include one or more deep learning models 100, such as the object classification model. The deep learning model 100 may learn a neural network by using a pre-stored program.

An algorithm for operation of the processor 20 and the deep learning model 100 may be stored in a memory. The memory may comprise a hard disk drive, a flash memory, an electrically erasable programmable read-only memory (EEPROM), a static random access memory (SRAM), a ferro-electric RAM (FRAM), a phase-change RAM (PRAM), or a magnetic RAM (MRAM), a dynamic RAM (DRAM), a synchronous DRAM (SDRAM), a double date rate-SDRAM (DDR-SDRAM), and the like.

A driving controller 30 may be used to control the driving of a vehicle in response to a control signal from the processor 20. The driving controller 30 may include a steering controller, an engine controller, a brake controller, and a transmission control module. The driving controller 30 is not limited to a device installed on a vehicle that drives according to the autonomous driving level specified by the Society of Automotive Engineers. The driving controller 30 may refer to driving aids that increase user convenience under the control of the processor 20.

The steering controller may include a hydraulic power steering (HPS) system that controls steering by using hydraulic pressure generated by a hydraulic pump and/or a motor driven power steering system (hereinafter referred to as ‘MDPS’) that controls steering by using the output torque of an electric motor.

The engine controller may control the acceleration of the vehicle. The engine controller may be an actuator that controls the engine of a vehicle. The engine controller may be implemented with an engine management system (EMS). The engine controller may control the driving torque of an engine depending on accelerator pedal location information output from an accelerator pedal location sensor. The engine controller may control the output of an engine to follow the driving speed of the vehicle requested by the processor 100 during autonomous driving.

The brake controller may be implemented with an electronic stability control (ESC). The brake controller may be an actuator that controls the deceleration of the vehicle. The brake controller may control the brake pressure for the purpose of following the target speed requested by the processor 20. In other words, the brake controller may control the deceleration of the vehicle.

The transmission control module may be implemented with a shift-by-wire (SBW). The transmission control module may be an actuator for controlling the transmission of the vehicle. The shift controller may control the transmission of the vehicle based on a gear location and a gear state range.

An output device 40 may be configured to output object information detected based on an image under the control of the processor 20. The output device 40 may include a display 41 and a speaker 42. The processor 20 may visually express the detected object through the display 41. Additionally, or alternatively, the processor 20 may output a warning sound through the speaker 42 in response to detecting an obstacle that may pose a threat to safety.

An apparatus for building the deep learning model 100 and a method thereof, according to embodiments of the present disclosure of the present, disclosure are described in more detail below as follows.

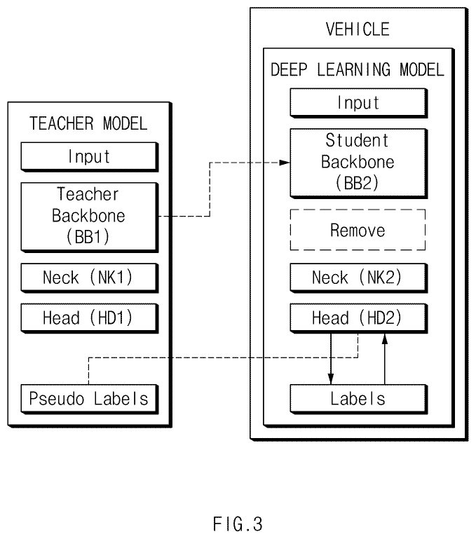

FIG. 3 is a diagram for describing an apparatus for building a deep learning model, according to an embodiment of the present disclosure.

Referring to FIG. 3, an apparatus for building a deep learning model according to an embodiment of the present disclosure may include a teacher model TM and a deep learning model SM.

The teacher model TM may be selected based on the performance in detecting objects from an image. The teacher model TM may be used when it takes a long time to detect an object from the image and/or a lot of computation is required, and may use a network with relatively better (e.g., excellent) object detection performance. For example, the teacher model TM may use DLA34 model, which has excellent object detection performance in images. However, the teacher model TM is not limited thereto.

The teacher model TM may include a first backbone BB1, a first neck NK1, and a first head HD1. The deep learning model SM may include a second backbone BB2, a second neck NK2, and a second head HD2. The first backbone BB1 and the second backbone BB2 may be feature extractors including one or more layers. Each of the first backbone BB1 and the second backbone BB2 may output a spatial feature map. The spatial feature map may include feature values corresponding one-to-one to coordinates on a 2D plane. Hereinafter, each of outputs of the first backbone BB1 and the second backbone BB2 is classified into a first spatial feature map and a second spatial feature map.

The first neck NK1 may be a structure for connecting the first backbone BB1 and the first head HD1. The second neck NK2 may be a structure for connecting the second backbone BB2 and the second head HD2.

Each of the first head HD1 and the second head HD2 may output a heatmap. The heatmap may include a center value indicating center information of an object detected from an image. The center value may correspond one-to-one to the coordinates of the heatmap.

The deep learning model SM according to an embodiment of the present disclosure may be a model for detecting an object from an image by learning images obtained in real time. The deep learning model SM according to an embodiment of the present disclosure may be updated in a method in which it is learned by imitating the teacher model TM. The deep learning model SM may be installed on devices requiring image learning in real time. The deep learning model SM may, for example, detect an object by learning images obtained by the camera 10 of a vehicle VEH in real time while being mounted on the vehicle VEH. The deep learning model SM may be important for optimization and light-weighting so as to be suitable for the field of use or a target. Accordingly, to compensate for the lack of object detection performance, the deep learning model SM according to an embodiment of the present disclosure may be updated by performing learning to imitate the teacher model TM.

Despite a lightweight network of which the object recognition performance is insufficient compared to the teacher model TM, the deep learning model SM may provide the object recognition performance of the teacher model TM by imitating the teacher model TM based on knowledge distillation technique.

For example, the deep learning model SM may be learned to imitate the spatial feature map output by the first backbone BB1 of the teacher model TM. Moreover, the deep learning model SM may be learned to imitate a heatmap output by the first head HD1 of the teacher model TM. In other words, the spatial feature map output by the first backbone BB1 of the teacher model TM and the heatmap output by the first head HD1 of the teacher model TM may be used as pseudo labels for learning the deep learning model SM.

A method of building the deep learning model SM, according to an embodiment of the present disclosure, is described in more detail below as follows.

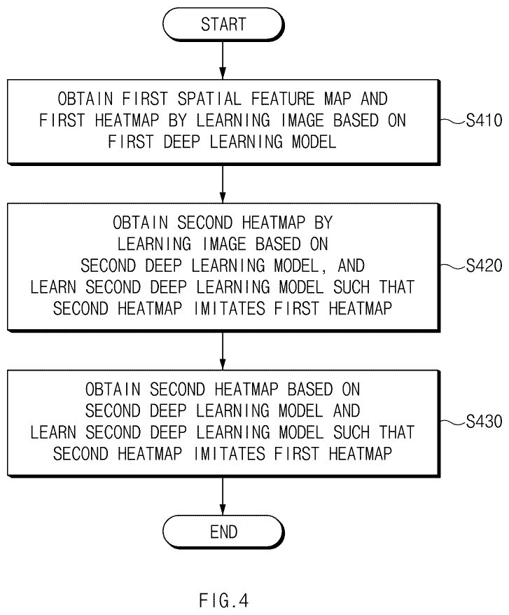

FIG. 4 is a flowchart for describing a method of building a deep learning model, according to an embodiment of the present disclosure. With reference to FIGS. 3 and 4, the method of building a deep learning model according to an embodiment of the present disclosure is as follows.

In the examples below, the teacher model TM is referred to as the first deep learning model TM. The deep learning model SM corresponding to a student model is referred to as the second deep learning model SM.

In an operation S410, the first deep learning model TM may output a first spatial feature map and a first heatmap by learning an image.

The first backbone BB1 of the first deep learning model TM may output the first spatial feature map by learning the image. The first backbone BB1 may include a plurality of layers, and each of the layers may output one spatial feature map. In other words, the first spatial feature map may be output as many as the number of layers constituting the first backbone BB1.

The first head HD1 of the first deep learning model TM may output image detection results. The first head HD1 may output a heatmap corresponding to the predetermined number of classes. For example, when the class includes a vehicle, a person, and a two-wheeled vehicle, the first head HD1 may output a heatmap corresponding to each class.

In an operation S420, a second spatial feature map may be obtained by learning an image based on the second deep learning model, and the second deep learning model may be learned such that the second spatial feature map imitates the first spatial feature map.

The second backbone BB2 of the second deep learning model SM may output a second spatial feature map by learning images. The second backbone BB2 may include a plurality of layers, and each of the layers may output one spatial feature map.

The second head HD2 of the deep learning model SM may output image detection results. The second head HD2 may output a heatmap corresponding to a predetermined number of classes.

The second deep learning model SM may perform imitation learning based on a representative feature value obtained from the spatial feature map. For example, the second deep learning model SM may proceed with learning such that a second representative feature value obtained from the second spatial feature map imitates a first representative feature value obtained from the first spatial feature map. The first representative feature value may be obtained by the first deep learning model TM. The second representative feature value may be obtained by the second deep learning model SM.

The representative feature value may indicate characteristics of feature values arranged in a straight direction. The representative feature value may be the sum or average of feature values arranged in a straight direction in the spatial feature map. Alternatively, the representative feature value may be obtained by selecting the maximum or minimum value among feature values arranged in a straight direction in the spatial feature map. A method of obtaining a representative feature value may be selected in a method capable of expressing location information of an object.

In an operation S430, a second heatmap may be obtained based on the second deep learning model, and a second deep learning model may be learned such that the second heatmap imitates the first heatmap.

The second head HD2 of the second deep learning model SM may output a heatmap corresponding to the predetermined number of classes.

The second deep learning model SM may proceed with learning such that the second heatmap imitates the first heatmap, and heatmaps that are targets of imitation learning may correspond to the same class. For example, the second deep learning model SM may proceed with learning such that the second heatmap, of which the class corresponds to a vehicle, imitates the first heatmap of which the class is a vehicle.

The second deep learning model SM may perform imitation learning based on the representative center value obtained from the heatmap. For example, the second deep learning model SM may proceed with learning such that the second representative center value obtained from the second heatmap imitates the first representative center value obtained from the first heatmap. The first representative center value may be obtained by the first deep learning model TM. The second representative center value may be obtained by the second deep learning model SM.

The representative center value may indicate characteristics of center values arranged in a straight line. The representative center value may be the sum or average of center values arranged in a straight line in the heatmap. Alternatively, the representative center value may be obtained by selecting the maximum or minimum value among center values arranged in a straight line in the heatmap. A method of obtaining a representative center value may be selected in a method capable of expressing location information of an object.

A method of building a deep learning model, according to an embodiment of the present disclosure, is described in more detail below as follows.

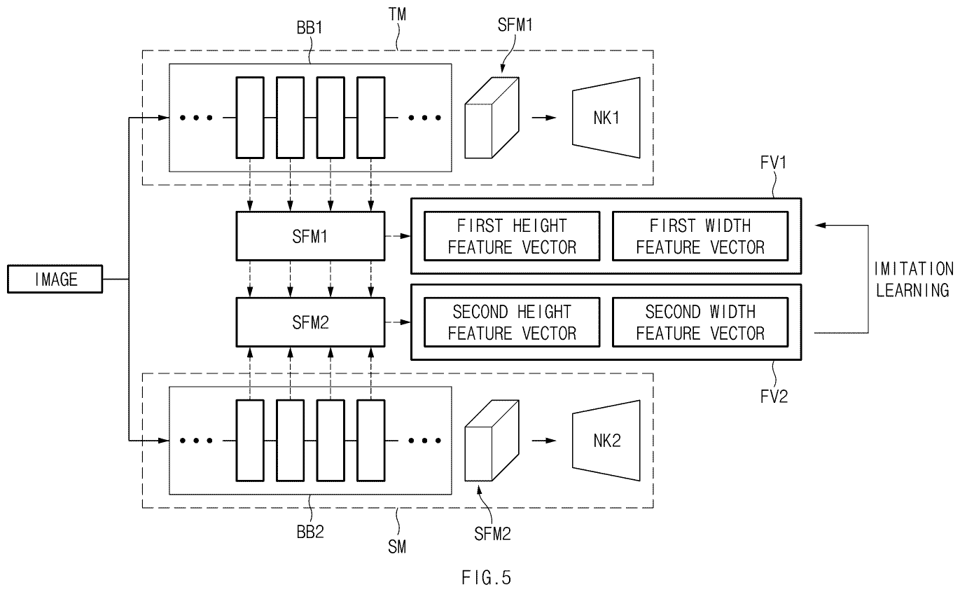

FIG. 5 is a diagram for describing imitation learning of a backbone network, according to an embodiment of the present disclosure.

Referring to FIG. 5, the first backbone BB1 of the first deep learning model TM may output a first spatial feature map SFM1, and the second backbone BB2 of the second deep learning model SM may output a second spatial feature map SFM2.

The first deep learning model TM may obtain a first feature vector FV1 from the first spatial feature map SFM1. The first feature vector FV1 may include a first height feature vector and a first width feature vector.

The second deep learning model SM may obtain a second feature vector FV2 from the second spatial feature map SFM2. The second feature vector FV2 may include a second height feature vector and a second width feature vector. A method of obtaining the first feature vector FV1 and the second feature vector FV2, according to an embodiment of the resent disclosure, is described in more detail below as follows.

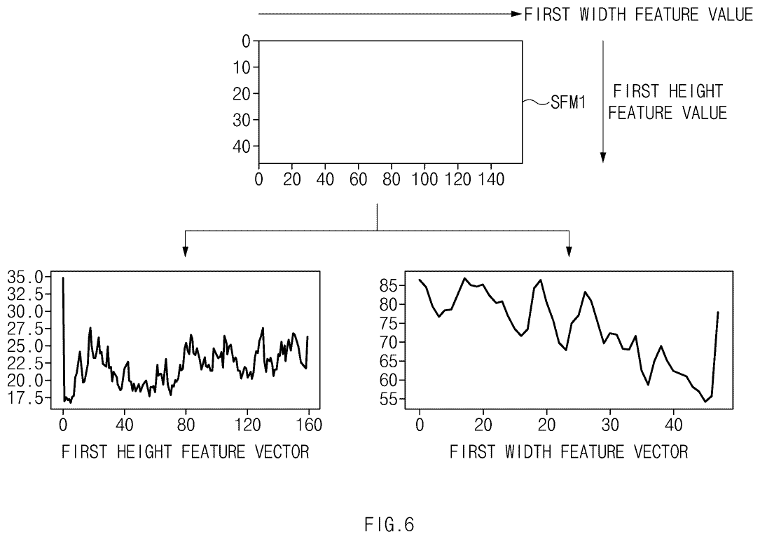

FIG. 6 is a diagram for describing a method of obtaining a feature vector, according to an embodiment of the present disclosure. FIG. 6 is a diagram for describing that a first deep learning model obtains a first height feature vector and a second width feature vector from a first spatial feature map. In the description of FIG. 6 below, the number of x-coordinates of a spatial feature map is ‘m’ (‘m’ is a natural number) and the number of y-coordinates of the spatial feature map is ‘n’ (‘n’ is a natural number).

Referring to FIGS. 5 and 6, the first deep learning model TM may obtain the first representative feature value from the first spatial feature map SFM1 and may obtain the first feature vector FV1 based on the first representative feature value.

The first representative feature value may be the first height feature value or the second width feature value.

The first deep learning model TM may obtain the first height feature value from feature values with the same x-axis coordinate value in the first spatial feature map SFM1. The first height feature value may be the sum of feature values, each of which has the same x-axis coordinate value. For example, the first height feature value may be the sum of ‘n’ feature values, each of which has the first coordinate value (x=1) on an x-axis. In this way, the first deep learning model TM may obtain ‘m’ first height feature values corresponding to ‘m’ x-coordinates.

The first deep learning model TM may generate a first height feature vector based on the first height feature value. The first height feature value may be a 1×m vector having ‘m’ first height feature values as elements.

The first deep learning model TM may obtain the first width feature value from feature values, each of which has the same y-axis coordinate value in the first spatial feature map SFM1. The first width feature value may be the sum of feature values, each of which has the same y-axis coordinate value. For example, the first width feature value may be the sum of ‘m’ feature values, each of which has the first coordinate value (y=1) on a y-axis. In this way, the first deep learning model TM may obtain ‘n’ first width feature values corresponding to ‘n’ y-coordinates.

The first deep learning model TM may generate a first width feature vector based on the first width feature value. The first width feature vector may be a 1×n vector having ‘n’ first width feature values as elements.

As in the above description, the second deep learning model SM may obtain the second representative feature value from the second spatial feature map SFM2 and may obtain the second feature vector FV2 based on the second representative feature value.

The second representative feature value may be the second height feature value or the second width feature value.

The second deep learning model SM may obtain the second height feature value from feature values, each of which has the same x-axis coordinate value in the second spatial feature map SFM2. The second height feature value may be the sum of feature values, each of which has the same x-axis coordinate value. For example, the second height feature value may be the sum of ‘n’ feature values, each of which has the first coordinate value (x=1) on an x-axis. In this way, the first deep learning model TM may obtain ‘m’ second height feature values corresponding to ‘m’ x-coordinates.

The second deep learning model SM may generate a second height feature vector based on the second height feature value. The second height feature value may be a 1×m vector having ‘m’ second height feature values as elements.

The second deep learning model SM may obtain the second width feature value from feature values, each of which has the same y-axis coordinate value in the second spatial feature map SEM2. The second width feature value may be the sum of feature values, each of which has the same y-axis coordinate value. For example, the second width feature value may be the sum of ‘m’ feature values, each of which has the first coordinate value (y=1) on a y-axis. In this way, the second deep learning model SM may obtain ‘n’ second width feature values corresponding to ‘n’ y-coordinates.

The second deep learning model SM may generate a second width feature vector based on the second width feature value. The second width feature vector may be a 1×n vector having ‘n’ second width feature values as elements.

The second deep learning model SM may proceed with learning to reduce a difference between the second feature vector FV2 and the first feature vector FV1. For example, the second deep learning model SM may proceed with learning to reduce a difference between the second height feature vector and the first height feature vector. Alternatively, the second deep learning model SM may proceed with learning to reduce a difference between the second width feature vector and the first width feature vector.

The second deep learning model SM according to the embodiment may obtain a feature distribution based on the feature vector and may proceed with learning to reduce the deviation in the feature distribution. A method of learning the second deep learning model SM based on the feature distribution, according to an embodiment of the present disclosure, is described in more detail below as follows.

The first deep learning model TM may obtain a first height feature distribution based on the first height feature vector. To this end, the first deep learning model TM may obtain the first height feature distribution indicating the first height feature value according to an x-coordinate value by normalizing elements of the first height feature vector. For example, the first deep learning model TM may normalize each of elements to have a value greater than or equal to 0 and less than 1 such that the sum of all elements of the first height feature vector is 1. The first deep learning model TM may perform normalization by using softmax.

The first deep learning model TM may obtain a first width feature distribution based on the first width feature vector. To this end, the first deep learning model TM may obtain the first width feature distribution indicating the first width feature value according to a y-coordinate value by normalizing elements of the first width feature vector. For example, the first deep learning model TM may normalize each of elements to have a value greater than or equal to 0 and less than 1 such that the sum of all elements of the first width feature vector is 1. The first deep learning model TM may perform normalization by using softmax.

As in the above description, the second deep learning model SM may obtain the second height feature distribution based on the second height feature vector. To this end, the second deep learning model SM may obtain the first height feature distribution indicating the second height feature value according to an x-coordinate value by normalizing elements of the second height feature vector. For example, the second deep learning model SM may normalize each of elements to have a value greater than or equal to 0 and less than 1 such that the sum of all elements of the second height feature vector is 1. The second deep learning model SM may perform normalization by using softmax.

The second deep learning model SM may obtain a second width feature distribution based on the second width feature vector. To this end, the second deep learning model SM may obtain the second width feature distribution indicating the second width feature value according to a y-coordinate value by normalizing elements of the second width feature vector. For example, the second deep learning model SM may normalize each of elements to have a value greater than or equal to 0 and less than 1 such that the sum of all elements of the second width feature vector is 1. The second deep learning model SM may perform normalization by using softmax.

The second deep learning model SM may proceed with learning to reduce a difference between the second height feature distribution and the first height feature distribution. The second deep learning model SM may further proceed with learning to reduce a difference between the second width feature distribution and the first width feature distribution.

According to an embodiment, the second deep learning model SM may perform learning to reduce the difference between a height feature distribution and a width feature distribution by using Kullback-Leibler loss function.

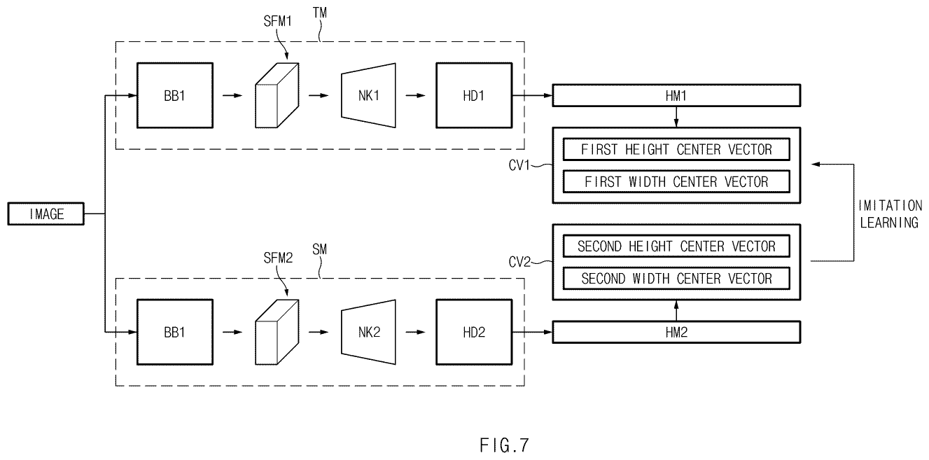

FIG. 7 is a diagram for describing imitation learning of a head, according to an embodiment of the present disclosure.

Referring to FIG. 7, the first head HD1 of the first deep learning model TM may output a first heatmap HM1. The second head HD2 of the second deep learning model SM may output a second heatmap HM2.

The first deep learning model TM may obtain a first center vector CV1 from the first heatmap HM1. The first center vector CV1 may include a first height center vector and a first width center vector.

The second deep learning model SM may obtain a second center vector CV2 from the second heatmap HM2. The second center vector CV2 may include a second height center vector and a second width center vector. A method of obtaining the first center vector CV1 and the second center vector CV2, according to an embodiment of the present disclosure, is described in more detail below as follows.

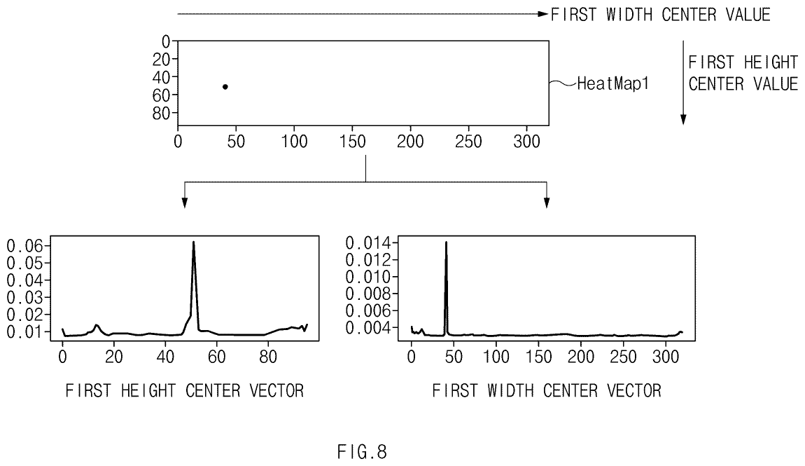

FIG. 8 is a diagram for describing a method of obtaining a center vector, according to an embodiment of the present disclosure. FIG. 8 is a diagram for describing that a first deep learning model obtains a first height center vector and a second width center vector from a first heatmap. In the description of FIG. 8, the number of x-coordinates of a center map is ‘i’ (‘i’ is a natural number) and the number of y-coordinates of the center map is ‘j’ (‘j’ is a natural number).

Referring to FIGS. 7 and 8, the first deep learning model TM may obtain a first representative center value from the first heatmap HM1 and may obtain the first center vector CV1 based on the first representative center value.

The first representative center value may be either the first height center value or the first width center value.

The first deep learning model TM may obtain the first height center value from center values with the same x-axis coordinate value in the first heatmap HM1. The first height center value may be the sum of center values, each of which has the same x-axis coordinate value. For example, the first height center value may be the sum of ‘j’ center values, each of which has the first coordinate value (x=1) on an x-axis. In this way, the first deep learning model TM may obtain ‘i’ first height center values corresponding to ‘i’ x-coordinates.

The first deep learning model TM may generate a first height center vector based on the first height center value. The first height center value may be a 1×i vector having the ‘i’ first height center values as elements.

The first deep learning model TM may obtain the first width center value from center values with the same y-axis coordinate value in the first heatmap HM1. The first width center value may be the sum of center values, each of which has the same y-axis coordinate value. For example, the first width center value may be the sum of ‘i’ center values, each of which has the first coordinate value (y=1) on a y-axis. In this way, the first deep learning model TM may obtain ‘j’ first width center values corresponding to ‘j’ y-coordinates.

The first deep learning model TM may generate a first width center vector based on the first width center value. The first width center vector may be a 1×j vector having the ‘j’ first width center values as elements.

As in the above description, the second deep learning model SM may obtain the second representative center value from the second heatmap HM2 and may obtain the second center vector CV2 based on the second representative center value.

The second representative center value may be either the second height center value or the second width center value.

The second deep learning model SM may obtain the second height center value from center values with the same x-axis coordinate value in the second heatmap HM2. The second height center value may be the sum of center values, each of which has the same x-axis coordinate value. For example, the second height center value may be the sum of ‘j’ center values, each of which has the first coordinate value (x=1) on an x-axis. In this way, the second deep learning model SM may obtain ‘i’ second height center values corresponding to ‘i’ x-coordinates.

The second deep learning model SM may generate a second height center vector based on the second height center value. The second height center value may be a 1×i vector having the ‘i’ second height center values as elements.

The second deep learning model SM may obtain the second width center value from center values with the same y-axis coordinate value in the second heatmap HM2. The second width center value may be the sum of center values, each of which has the same y-axis coordinate value. For example, the second width center value may be the sum of ‘i’ center values, each of which has the first coordinate value (y=1) on a y-axis. In this way, the second deep learning model SM may obtain ‘j’ second width center values corresponding to ‘j’ y-coordinates.

The second deep learning model SM may generate a second width center vector based on the second width center value. The second width center vector may be a 1×j vector having the ‘j’ second width center values as elements.

The second deep learning model SM may proceed with learning to reduce a difference between the second center vector CV2 and the first center vector CV1. For example, the second deep learning model SM may proceed with learning to reduce a difference between the second height center vector and the first height center vector. Alternatively, the second deep learning model SM may proceed with learning to reduce a difference between the second width center vector and the first width center vector.

The second deep learning model SM according to the embodiment may obtain a center distribution based on the center vector and may proceed with learning to reduce the deviation in the center distribution. A method of learning the second deep learning model SM based on the center distribution, according to an embodiment of the present disclosure, is described in more detail below as follows.

The first deep learning model TM may obtain a first height center distribution based on the first height center vector. To this end, the first deep learning model TM may obtain the first height center distribution indicating the first height center value according to an x-coordinate value by normalizing elements of the first height center vector. For example, the first deep learning model TM may normalize each of elements to have a value greater than or equal to 0 and less than 1 such that the sum of all elements of the first height center vector is 1. The first deep learning model TM may perform normalization by using softmax.

The first deep learning model TM may obtain a first width center distribution based on the first width center vector. To this end, the first deep learning model TM may obtain the first width center distribution indicating the first width center value according to a y-coordinate value by normalizing elements of the first width center vector. For example, the first deep learning model TM may normalize each of elements to have a value greater than or equal to 0 and less than 1 such that the sum of all elements of the first width center vector is 1. The first deep learning model TM may perform normalization by using softmax.

As in the above description, the second deep learning model SM may obtain the second height center distribution based on the second height center vector. To this end, the second deep learning model SM may obtain the second height center distribution indicating the second height center value according to an x-coordinate value by normalizing elements of the second height center vector. For example, the second deep learning model SM may normalize each of elements to have a value greater than or equal to 0 and less than 1 such that the sum of all elements of the second height center vector is 1.

The second deep learning model SM may obtain a second width center distribution based on the second width center vector. To this end, the second deep learning model SM may obtain the second width center distribution indicating the second width center value according to a y-coordinate value by normalizing elements of the second width center vector. For example, the second deep learning model SM may normalize each of elements to have a value greater than or equal to 0 and less than 1 such that the sum of all elements of the second width center vector is 1.

The second deep learning model SM may proceed with learning to reduce a difference between the second height center distribution and the first height center distribution. The second deep learning model SM may proceed with learning to reduce a difference between the second width center distribution and the first width center distribution.

According to an embodiment, the second deep learning model SM may perform learning to reduce the difference between a height center distribution and a width center distribution by using Kullback-Leibler loss function.

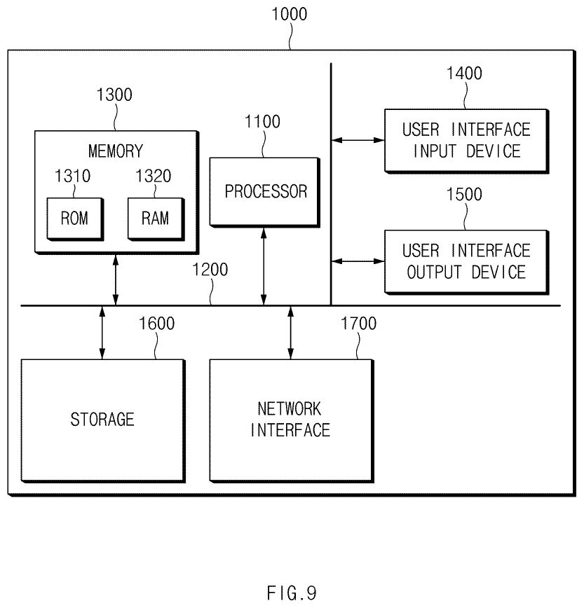

FIG. 9 illustrates a computing system, according to an embodiment of the present disclosure.

Referring to FIG. 9, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the methods or algorithms described in connection with the embodiments of the present disclosure may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely illustrative of the technical idea of the present disclosure. Various modifications and alterations may be made by one having ordinary skill in the art without departing from the essential characteristic of the present disclosure.

Accordingly, the embodiments of the present disclosure described herein are intended not to limit but to explain the technical idea of the present disclosure. The scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, because a lightweight deep learning model is learned to imitate a teacher model with relatively better (e.g., excellent) object recognition performance, object recognition at a teacher model level may be performed by using a lightweight deep learning model suitable for mounting on an autonomous vehicle.

Moreover, according to an embodiment of the present disclosure, because object recognition performance is improved to a teacher model level regardless of the type of a deep learning model, the types of deep learning models capable of being applied to embedded systems of autonomous vehicles may be expanded.

Moreover, a variety of effects directly or indirectly understood through the present disclosure may be provided.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. An apparatus, comprising:
a memory configured to store program instructions; and
a processor configured to execute the program instructions to implement a first deep learning model and a second deep learning model;
wherein the first deep learning model configured to
obtain a first spatial feature map by learning an image, and
obtain a first heatmap including center information of an object belonging to the image by learning the image; and
wherein the second deep learning model configured to
obtain a second spatial feature map by learning the image,
perform learning such that the second spatial feature map imitates the first spatial feature map,
obtain a second heatmap including a center of the object, and
perform learning such that the second heatmap imitates the first heatmap.

2. The apparatus of claim 1, wherein the second deep learning model is configured to:
output the second spatial feature map through a backbone.

3. The apparatus of claim 2, wherein:
the first deep learning model is configured to
obtain a first representative feature value of feature values arranged in a straight direction in the first spatial feature map, and
obtain a first feature vector of a single row by sorting the first representative feature value; and
the second deep learning model is configured to
obtain a second representative feature value of feature values arranged in a straight direction in the second spatial feature map,
obtain a second feature vector of a single row by sorting the second representative feature value, and
perform imitation learning to reduce a difference between the second feature vector and the first feature vector.

4. The apparatus of claim 3, wherein:
the first deep learning model is configured to
obtain a first height feature value based on the feature values having x-axis coordinate values same as each other,
obtain a first height feature vector based on the first height feature value,
obtain a first width feature value based on the feature values having y-axis coordinate values same as each other, and
obtain a first width feature vector based on the first width feature value; and
the second deep learning model is configured to
obtain a second height feature value based on the feature values having the x-axis coordinate values same as each other,
obtain a second height feature vector based on the second height feature value,
obtain a second width feature value based on the feature values having the y-axis coordinate values same as each other, and
obtain a second width feature vector based on the second width feature value.

5. The apparatus of claim 4, wherein the second deep learning model is configured to:
perform learning to reduce a difference between the second height feature vector and the first height feature vector; and
perform learning to reduce a difference between the second width feature vector and the first width feature vector.

6. The apparatus of claim 5, wherein:
the first deep learning model is configured to
obtain a first height distribution by normalizing the first height feature vector, and
obtain a first width distribution by normalizing the first width feature vector; and
the second deep learning model is configured to
obtain a second height distribution by normalizing the second height feature vector,
obtain a second width distribution by normalizing the second width feature vector, and
perform learning such that the second height distribution imitates the first height distribution and the second width distribution imitates the first width distribution.

7. The apparatus of claim 1, wherein the second deep learning model is configured to:
output the second heatmap through a head.

8. The apparatus of claim 7, wherein:
the first deep learning model is configured to
obtain a first representative center value of center values arranged in a straight direction in the first heatmap, and
obtain a first center vector of a single row by sorting the first representative center value; and
the second deep learning model is configured to
obtain a second representative center value of center values arranged in a straight direction in the second heatmap,
obtain a second center vector of a single row by sorting the second representative center value, and
perform imitation learning to reduce a difference between the second center vector and the first center vector.

9. The apparatus of claim 8, wherein:
the first deep learning model is configured to
obtain a first height center value based on the center values having x-axis coordinate values same as each other,
obtain a first height center vector based on the first height center value,
obtain a first width center value based on the center values having y-axis coordinate values same as each other, and
obtain a first width center vector based on the first width center value; and
the second deep learning model is configured to
obtain a second height center value based on the center values having the x-axis coordinate values same as each other,
obtain a second height center vector based on the second height center value,
obtain a second width center value based on the center values having the y-axis coordinate values same as each other, and
obtain a second width center vector based on the second width center value.

10. The apparatus of claim 9, wherein the second deep learning model is configured to:
perform learning to reduce a difference between the second height center vector and the first height center vector; and
perform learning to reduce a difference between the second width center vector and the first width center vector.

11. The apparatus of claim 10, wherein:
the first deep learning model is configured to
obtain a first height distribution by normalizing the first height center vector, and
obtain a first width distribution by normalizing the first width center vector; and
the second deep learning model is configured to
obtain a second height distribution by normalizing the second height center vector,
obtain a second width distribution by normalizing the second width center vector, and
perform learning such that the second height distribution imitates the first height distribution and the second width distribution imitates the first width distribution.

12. A method comprising:
obtaining a first spatial feature map and a first heatmap including center information of an object belonging to an image by learning the image based on a first deep learning model;
obtaining a second spatial feature map by learning the image based on a second deep learning model;
performing learning of the second deep learning model such that the second spatial feature map imitates the first spatial feature map;
obtaining a second heatmap including a center of the object based on the second deep learning model; and
performing learning of the second deep learning model such that the second heatmap imitates the first heatmap.

13. The method of claim 12, wherein performing learning of the second deep learning model such that the second spatial feature map imitates the first spatial feature map includes:
obtaining a first representative feature value of feature values arranged in a straight direction in the first spatial feature map;
obtaining a first feature vector of a single row by sorting the first representative feature value;
obtaining a second representative feature value of feature values arranged in a straight direction in the second spatial feature map;
obtaining a second feature vector of a single row by sorting the second representative feature value; and
learning the second deep learning model to reduce a difference between the second feature vector and the first feature vector.

14. The method of claim 13, wherein:
obtaining the first feature vector includes
obtaining a first height feature value based on the feature values having x-axis coordinate values same as each other,
obtaining a first height feature vector based on the first height feature value,
obtaining a first width feature value based on the feature values having y-axis coordinate values same as each other, and
obtaining a first width feature vector based on the first width feature value; and
obtaining of the second feature vector includes
obtaining a second height feature value based on the feature values having the x-axis coordinate values same as each other,
obtaining a second height feature vector based on the second height feature value,
obtaining a second width feature value based on the feature values having the y-axis coordinate values same as each other, and
obtaining a second width feature vector based on the second width feature value.

15. The method of claim 14, wherein performing learning of the second deep learning model such that the second spatial feature map imitates the first spatial feature map includes:
performing learning to reduce a difference between the second height feature vector and the first height feature vector; and
performing learning to reduce a difference between the second width feature vector and the first width feature vector.

16. The method of claim 15, wherein performing learning of the second deep learning model such that the second spatial feature map imitates the first spatial feature map further includes:
obtaining a first height distribution by normalizing the first height feature vector;
obtaining a first width distribution by normalizing the first width feature vector;
obtaining a second height distribution by normalizing the second height feature vector;
obtaining a second width distribution by normalizing the second width feature vector; and
performing learning of the second deep learning model such that the second height distribution imitates the first height distribution and the second width distribution imitates the first width distribution.

17. The method of claim 12, wherein performing learning of the second deep learning model such that the second heatmap imitates the first heatmap includes:
obtaining, by the first deep learning model, a first representative center value of center values arranged in a straight direction in the first heatmap;
obtaining, by the first deep learning model, a first center vector of a single row by sorting the first representative center value;
obtaining, by the second deep learning model, a second representative center value of center values arranged in a straight direction in the second heatmap;
obtaining, by the second deep learning model, a second center vector of a single row by sorting the second representative center value; and
performing, by the second deep learning model, imitation learning to reduce a difference between the second center vector and the first center vector.

18. The method of claim 17, wherein performing learning of the second deep learning model such that the second heatmap imitates the first heatmap includes:
obtaining, by the first deep learning model, a first height center value based on the center values having x-axis coordinate values same as each other;
obtaining, by the first deep learning model, a first height center vector based on the first height center value;
obtaining, by the first deep learning model, a first width center value based on the center values having y-axis coordinate values same as each other, and obtaining a first width center vector based on the first width center value;
obtaining, by the second deep learning model, a second height center value based on the center values having the x-axis coordinate values same as each other;
obtaining, by the second deep learning model, a second height center vector based on the second height center value;
obtaining, by the second deep learning model, a second width center value based on the center values having the y-axis coordinate values same as each other; and
obtaining, by the second deep learning model, a second width center vector based on the second width center value.

19. The method of claim 18, wherein performing learning of the second deep learning model such that the second heatmap imitates the first heatmap includes:
learning the second deep learning model to reduce a difference between the second height center vector and the first height center vector; and
learning the second deep learning model to reduce a difference between the second width center vector and the first width center vector.

20. The method of claim 19, wherein performing learning of the second deep learning model such that the second heatmap imitates the first heatmap includes:
obtaining, by the first deep learning model, a first height distribution by normalizing the first height center vector;
obtaining, by the first deep learning model, a first width distribution by normalizing the first width center vector;
obtaining, by the second deep learning model, a second height distribution by normalizing the second height center vector;
obtaining, by the second deep learning model, a second width distribution by normalizing the second width center vector; and
performing, by the second deep learning model, learning such that the second height distribution imitates the first height distribution and the second width distribution imitates the first width distribution.
